(19) United States
(12) Patent Application Publication
(10) Pub. No.: US 2026/0246195 A1
(43) Pub. Date: Aug. 20, 2026

(54) CONNECTOR

(71) Applicant: SUMITOMO WIRING SYSTEMS, LTD., Mie (JP)

(72) Inventors: Takaya GOTO, Mie (JP); Yuta INOUE, Mie (JP)

(21) Appl. No.: 19/538,463

(22) Filed: Feb. 12, 2026

(30) Foreign Application Priority Data
Feb. 19, 2025 (JP) 2025-024752

(51) Int. Cl. H01R 13/52; H01R 13/506; H01R 13/629; H01R 13/631

(52) U.S. Cl. CPC H01R 13/5219; H01R 13/506; H01R 13/5202; H01R 13/62955; H01R 13/62977; H01R 13/6315

(57) ABSTRACT

A connector includes a first connector and a second connector. The first connector includes a first housing including a mating tubular portion, and a lever. The second connector has a second housing body, and cam pins protruding outward from the second housing body. The lever has cam plates, and the cam plates have cam grooves. The mating tubular portion has through grooves through which the cam pins are inserted. The first housing has an extended portion extending outward from a lower end portion of the mating tubular portion. The extended portion is provided with through holes that are in communication with lower end portions of the through grooves. The second housing body has blocking portions each disposed in a region extending from the lower end portion of the through groove to the through hole in a mated state.

### CROSS-REFERENCE TO RELATED APPLICATIONS

This application is based on and claims priority from Japanese Patent Application No. 2025-024752, filed on February 19, 2025, with the Japan Patent Office, the disclosure of which is incorporated herein in its entirety by reference.

### TECHNICAL FIELD

The present disclosure relates to a connector.

### BACKGROUND

The connector described in JP 2024-135324 A includes a housing that is mateable with a mating connector and a lever rotatably supported by the housing. The housing has an outer wall portion and an extended wall portion extending outward from the outer wall portion. A through groove is formed in the outer wall portion, and a through hole is formed in the extended wall portion. A cam groove is formed in the lever. The mating connector includes a cam pin that engages with the cam groove through the through groove and the through hole. The lever is provided with a protrusion portion that blocks the through groove and the through hole when the connector is mated with the mating connector.

### SUMMARY

In a case of a connector provided with a lever such as that of JP 2024-135324 A, there has been a need to form a through groove and a through hole as a path through which a cam pin is inserted such that the cam pin can engage with a cam groove of the lever. For this reason, there has been the possibility that water would enter the connector through the through groove and the through hole.

In this regard, according to JP 2024-135324 A, water resistance can be improved by the lever blocking the through groove when the connector and the mating connector are mated with each other. In contrast, there has also been a demand for a technique for improving water resistance without significantly changing the structure of the lever.

In view of this, an object of the present disclosure is to improve water resistance of a connector provided with a lever.

A connector according to the present disclosure includes: a first connector; and a second connector that is mated with the first connector from below, wherein the first connector includes a first housing including a mating tubular portion, and a lever rotatably supported by the first housing, the second connector includes a second housing body that is disposed inside the mating tubular portion in a mated state between the first connector and the second connector, and a cam pin protruding outward from the second housing body, the lever includes a cam plate that is disposed outside the mating tubular portion, the cam plate including a cam groove that engages with the cam pin, the mating tubular portion includes a through groove that extends in an up-down direction and through which the cam pin is inserted, the first housing includes an extended portion extending outward from a lower end portion of the mating tubular portion, the extended portion is provided with a through hole that is in communication with a lower end portion of the through groove, and the second housing body includes a blocking portion that is disposed to extend from the lower end portion of the through groove to the through hole in the mated state.

According to the present disclosure, it is possible to provide a connector that can improve water resistance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector according to a first embodiment.

FIG. 2 is an exploded perspective view of the connector according to the first embodiment.

FIG. 3 is a cross-sectional view showing a state where a cam pin and a blocking portion are arranged in the up-down direction when a first connector and a second connector are mated with each other, in the connector according to the first embodiment.

FIG. 4 is a side view of the first housing of the connector according to the first embodiment.

FIG. 5 is a bottom view of the first housing of the connector according to the first embodiment.

FIG. 6 is an enlarged perspective view of a part that includes a blocking portion and a cam pin of a second housing, in the connector according to the first embodiment.

FIG. 7 is a partially enlarged cross-sectional view showing a state where, when the first connector and the second connector are mated with each other, a cam plate covers a higher portion of a through groove than a lower end portion thereof, and the blocking portion blocks the through hole, in the connector according to the first embodiment.

FIG. 8 is a perspective view showing a state where the blocking portion is visible from between facing walls, in the connector according to the first embodiment.

FIG. 9 is a side view showing a state at the time of a start of mating between the first connector and the second connector, in the connector according to the first embodiment.

FIG. 10 is a side view showing a state at the time of completion of mating between the first connector and the second connector, in the connector according to the first embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

(1) A connector according to the present disclosure includes: a first connector; and a second connector that is mated with the first connector from below, wherein the first connector includes a first housing including a mating tubular portion, and a lever rotatably supported by the first housing, the second connector includes a second housing body that is disposed inside the mating tubular portion in a mated state between the first connector and the second connector, and a cam pin protruding outward from the second housing body, the lever includes a cam plate that is disposed outside the mating tubular portion, the cam plate including a cam groove that engages with the cam pin, the mating tubular portion includes a through groove that extends in an up-down direction and through which the cam pin is inserted, the first housing includes an extended portion extending outward from a lower end portion of the mating tubular portion, the extended portion is provided with a through hole that is in communication with a lower end portion of the through groove, and the second housing body includes a blocking portion that is disposed to extend from the lower end portion of the through groove to the through hole in the mated state.

With the configuration of above (1), the blocking portion can block the lower end portion of the through groove and the through hole, and thus, for example, even when the first connector is exposed to water, water or the like can be prevented from entering the second connector from the first connector side. Thus, the connector according to the present disclosure can improve water resistance even under the circumstances that providing a lever results in formation of a through groove and a through hole.

(2) In the connector according to above (1), preferably, the blocking portion is disposed to protrude outward from the second housing body, below the cam pin, and, in a direction in which the blocking portion protrudes outward from the second housing body, a leading end surface of the blocking portion is positioned at the same position as a leading end surface of the cam pin or outward of the leading end surface of the cam pin.

With the configuration of above (2), a protruding length of the blocking portion can be set so as to block the through hole, and thus water resistance can be secured.

(3) In the connector according to above (1) or (2), preferably, in the mated state, the cam plate covers a higher portion of the through groove than the lower end portion.

With the configuration of above (3), due to both the cam plate and the blocking portion, water or the like can be more reliably prevented from entering the through groove.

(4) In the connector according to any one of above (1) to (3), preferably, the first housing includes facing walls that face an outer surface of the cam plate, and, in the mated state, a pair of facing walls are disposed on opposite sides of the blocking portion as viewed from outside.

With the configuration of above (4), also due to the facing walls, water can be prevented from entering the through groove and the through hole. In addition, by visually recognizing the blocking portion from outside through between the pair of facing walls, it is possible to detect that the first connector and the second connector are in the mated state.

(5) In the connector according to any one of above (1) to (4), preferably, an upper end of the blocking portion has an inclined surface that is positioned above the extended portion in the mated state, and is inclined downward toward the extended portion.

With the configuration of above (5), even when the blocking portion is exposed to water, the inclined surface can function as a drainage surface for directing water to the extended portion side, and thus water or the like can be more reliably kept from entering the through groove and the through hole.

### Detailed Description of Embodiments of the Present Disclosure

Specific examples of embodiment of the present disclosure will be described below with reference to the drawings. Note that the present invention the present disclosure is not limited to these illustrations, but is indicated by the claims, and is intended to include all modifications that are within the meanings and the scope that are equivalent to those of the claims.

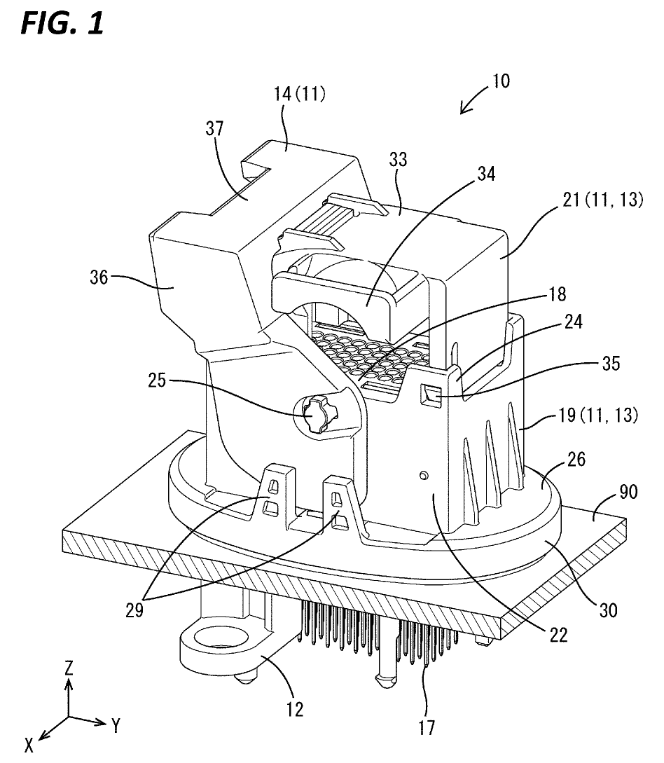

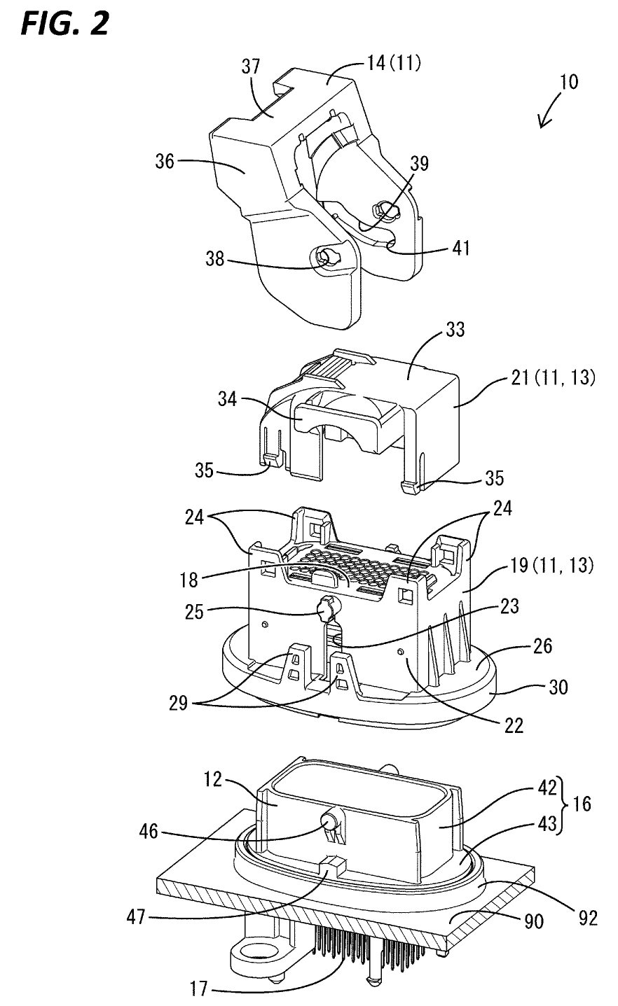

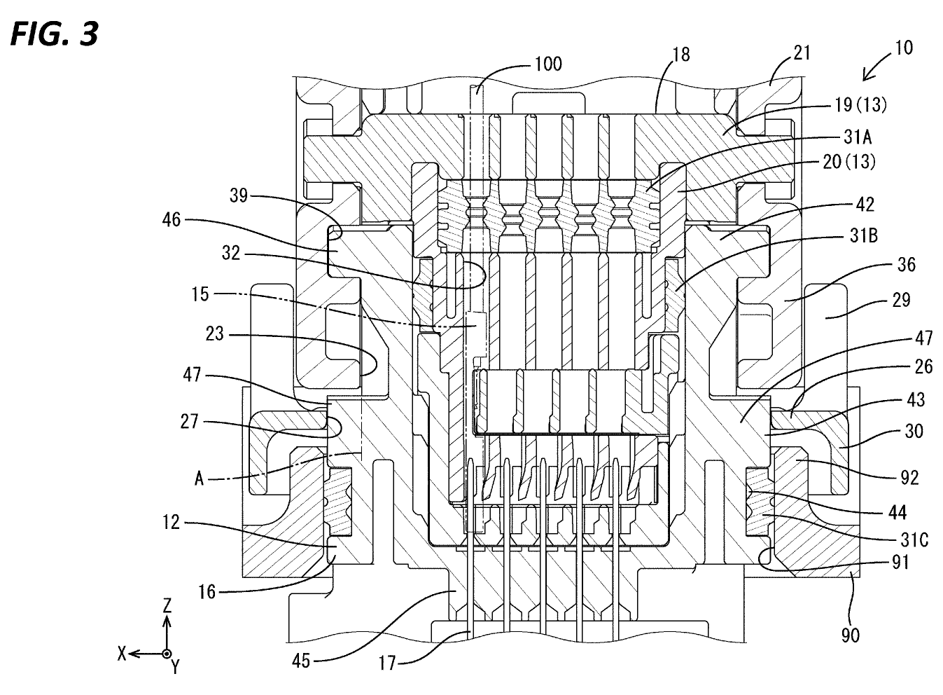

As shown in FIGS. 1 and 2, a connector 10 according to a first embodiment includes a first connector 11 and a second connector 12 that are mateable with each other. In the first embodiment, the first connector 11 is a female connector, and the second connector 12 is a male connector. The first connector 11 includes a first housing 13, and a lever 14 that is rotatably supported by the first housing 13. As shown in FIG. 3, the first housing 13 accommodates a plurality of first terminal fittings 15 that are female terminals (for convenience of illustration, only one first terminal fitting 15 is illustrated). The second connector 12 includes a second housing 16, and a plurality of second terminal fittings 17 that are male terminals and are accommodated in the second housing 16. Note that, in the following description, the up-down direction is equivalent to the mating direction of the first connector 11 and the second connector 12, and the first connector 11 is mated with the second connector 12 from above. Reference sign Z in FIG. 1 indicates an upward direction. Reference signs X and Y in FIG. 1 indicate a rightward direction and a frontward direction, respectively. In addition, in the following description, unless otherwise specified, an "inner side" refers to a side approaching the center of the connector 10, and an "outer side" refers to a side separating away from the center of the connector 10.

### First Embodiment

The connector 10 is a waterproof connector to be mounted in an automobile or the like. As shown in FIG. 2, the second connector 12 is fixed inside a case 90. Although not illustrated, the case 90 is box shaped. For convenience of illustration, only a portion of the case 90 is shown in the drawings. The case 90 is made of metal by aluminium die casting or the like. As shown in FIG. 3, the case 90 includes an opening portion 91 extending through the upper wall of the case 90 in the up-down direction, and a tubular portion 92 protruding upward from the entire periphery of the opening portion 91. An upper end edge of the tubular portion 92 has an oblong shape when viewed from above.

### First Connector 11

The first connector 11 and the second connector 12 are mated with each other by rotating the lever 14. The first terminal fittings 15 are made of conductive metal. As shown in FIG. 3, an electric wire 100 is connected to the first terminal fittings 15. The electric wires 100 are drawn out upward from an electric wire drawing surface 18 that is an upper surface of a later-described outer housing 19 of the first housing 13.

The first housing 13 includes the outer housing 19, an inner housing 20 that is accommodated in the outer housing 19, and an electric wire cover 21 that is mounted to the outer housing 19 from above. The outer housing 19, the inner housing 20, and the electric wire cover 21 are all made of a synthetic resin.

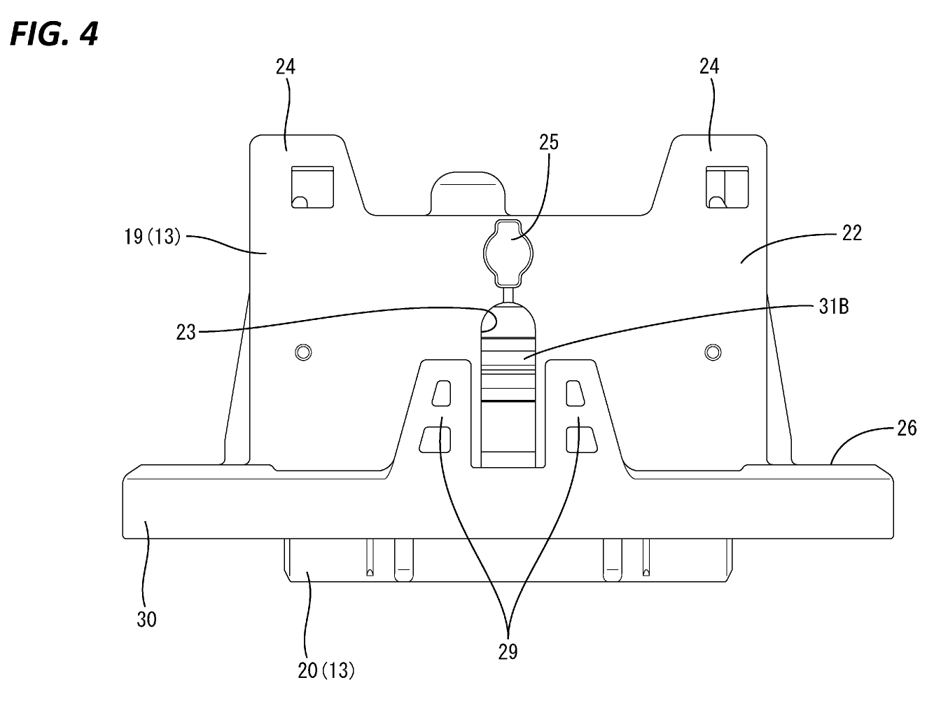

As shown in FIGS. 2 and 4, the outer housing 19 has a mating tubular portion 22. The mating tubular portion 22 is formed in a rectangular tubular shape by an upper wall, a front wall, a rear wall, a right wall, and a left wall. The electric wire drawing surface 18 is formed on the upper wall. The mating tubular portion 22 has a plurality of through grooves 23 through which later-described cam spins 46 of the second connector 12 are inserted. In the first embodiment, the through grooves 23 are respectively provided at intermediate portions in the front-rear direction of the left and right walls of the mating tubular portion 22. The through grooves 23 extend through the mating tubular portion 22 in the wall thickness direction (left-right direction, in-out direction) thereof. The through grooves 23 extend in the up-down direction. Lower ends of the through grooves 23 are open in lower end portions of both the left and right walls of the mating tubular portion 22. On both the left and right walls of the mating tubular portion 22, upper ends of the through grooves are closed at positions lower than support shafts 25 to be described later (see FIG. 4). At the four corners of an upper end portion of the mating tubular portion 22, respective cover lock receiving portions 24, to which the electric wire cover 21 is mounted, are provided to protrude upward.

The support shafts 25 are respectively provided to protrude outward from both the left and right walls of the mating tubular portion 22 (for convenience of illustration, only the support shaft 25 on one of the left and right sides is illustrated). The support shafts 25 are respectively fitted into later-described shaft holes 38 of the lever 14. The support shafts 25 rotatably support the lever 14.

The outer housing 19 also has an extended portion 26 extending outward from a lower end portion of the mating tubular portion 22. The extended portion 26 has an oblong shape longer in the front-rear direction than in the left-right direction as viewed from above. The extended portion 26 is formed in a flat plate shape extending in the front-rear direction and the left-right direction. The extended portion 26 is disposed to face an upper end edge of the tubular portion 92 of the case 90 in the mated state between the first connector 11 and the second connector 12.

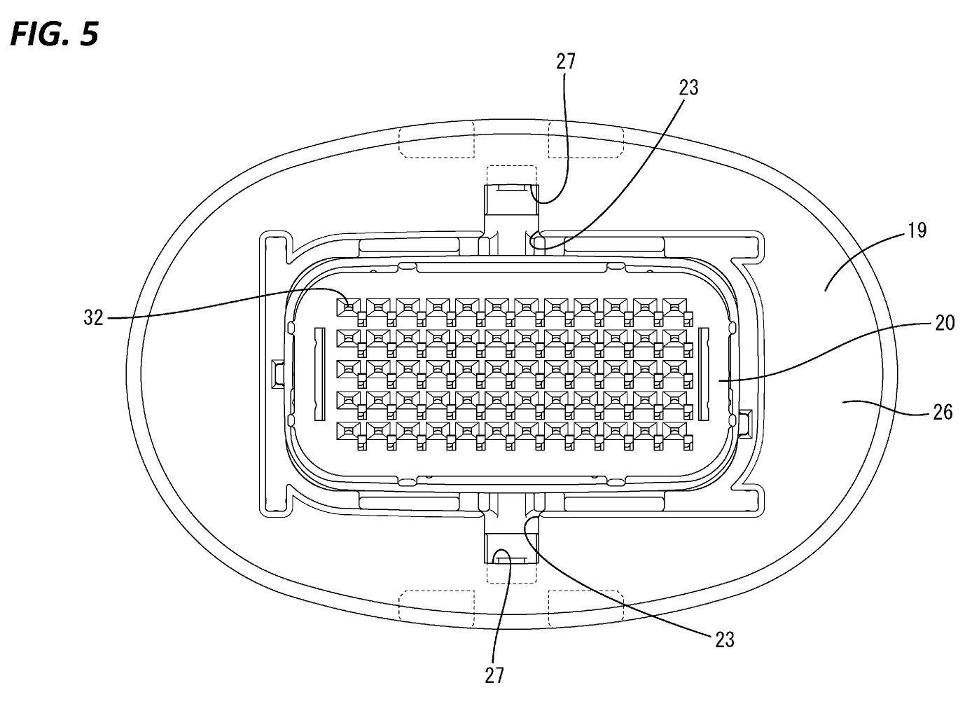

Through holes 27 that are respectively in communication with lower end portions of the through grooves 23 are provided at intermediate portions in the front-rear direction of the extended portion 26. The extended portion 26 extends outward from the lower end portion of the mating tubular portion 22, and thus the through holes 27 are disposed outward of the through grooves 23 (see the one-dot chain line A in FIG. 3. The one-dot chain line A is a reference line that separates the lower end portions of the through groove 23 and the through hole 27 into inner and outer sides). The through holes 27 extend through the extended portion 26 in the plate thickness direction (up-down direction). As shown in FIG. 5, the through holes 27 have a rectangular hole edge shape as viewed from below. Hole edges at right and left end portions of through holes 27 are formed to extend in the front-rear direction. Hole edges at front and rear end portions of the through holes 27 are formed to extend in the left-right direction.

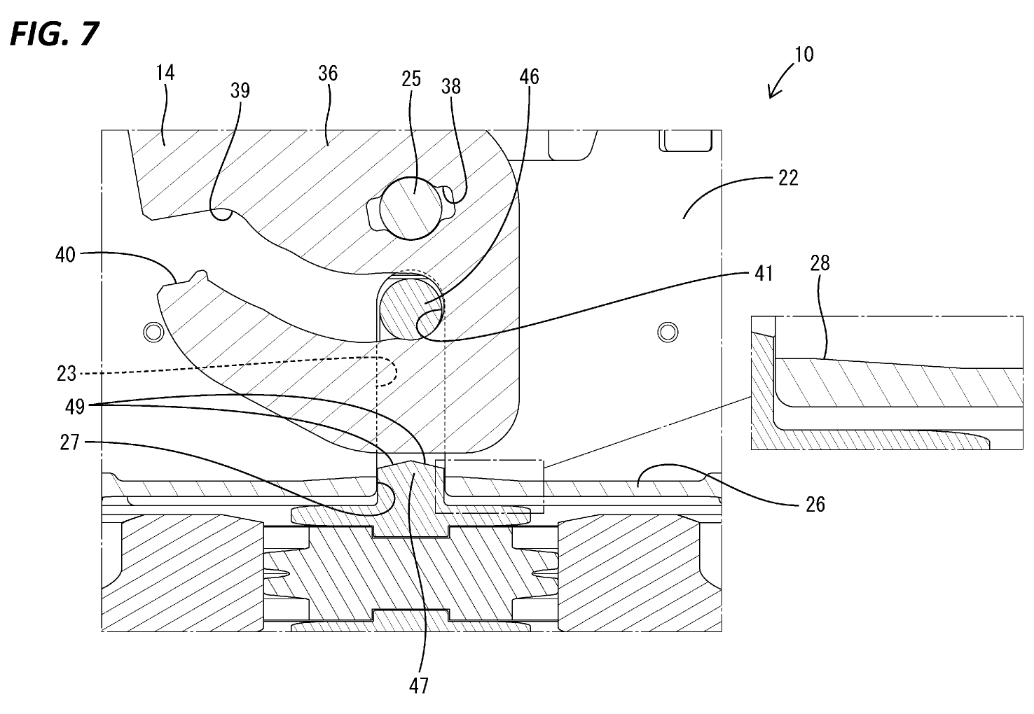

As shown in FIG. 7, on the upper surface of the extended portion 26, inclined portions 28 are respectively provided on the front and rear sides of each through hole 27. The inclined portions 28 are inclined downward from the front and rear opening ends of the through hole 27 toward front and rear sides, respectively.

On the outer peripheral edge of the extended portion 26, a plurality of facing walls 29 protruding upward are provided. As shown in FIG. 4, a pair of front and rear facing walls 29 are provided on each of the left and right end portions of the outer peripheral edge of the extended portion 26 (FIG. 4 only illustrates the facing walls 29 on one of the left and right sides). The pair of facing walls 29 provided in the front-rear direction are disposed on front and rear sides of the through groove 23 and the through hole 27. In the outer surface of each facing wall 29, recesses are provided at two locations arranged in the up-down direction. In a state where the lever 14 is mounted to the outer housing 19, later-described cam plates 36 of the lever 14 are each sandwiched between the mating tubular portion 22 and the facing walls 29, and the facing walls 29 face the outer surface of the cam plate 36.

In addition, the outer housing 19 has a peripheral wall 30 that protrudes downward from an outer peripheral edge of the extended portion 26 over the entire periphery. The peripheral wall 30 has an oblong shape longer in the front-rear direction than in the left-right direction as viewed from below. In a state where the first connector 11 and the second connector 12 are mated with each other, the peripheral wall 30 is mated with the tubular portion 92 from outside.

As described above, the inner housing 20 is accommodated and held in the mating tubular portion 22 of the outer housing 19. A seal member 31A is disposed to be sandwiched between the inner housing 20 and the outer housing 19 in the up-down direction. The seal member 31A maintains a liquid-tight state between the inner housing 20 and the outer housing 19, and around the electric wires 100 connected to the first terminal fittings 15. The inner housing 20 is fitted into a later-described second housing body 42 of the second connector 12. A seal member 31B is mounted on the outer peripheral surface of the inner housing 20. In the mated state between the inner housing 20 and the second housing body 42, the seal member 31B is in intimate contact with the outer peripheral surface of the inner housing 20 and the inner peripheral surface of the second housing body 42. The seal member 31B maintains a liquid-tight state between the first housing 13 and the second housing 16.

As shown in FIG. 5, the inner housing 20 is provided with a plurality of cavities 32 extending therethrough in the up-down direction. The cavities 32 are arranged in multiple columns in the front-rear direction and in multiple rows in the left-right direction. The first terminal fittings 15 are respectively inserted into the cavities 32 from above. In the mated state between the first connector 11 and the second connector 12, the first terminal fittings 15 are connected to the second terminal fittings 17, respectively.

As shown in FIG. 2, the electric wire cover 21 includes a back wall 33 facing the electric wire drawing surface 18 from above with a gap therebetween, an electric wire drawing portion 34 protruding rightward from the back wall 33, and pairs of front and rear cover lock portions 35 protruding downward from the back wall 33 and respectively provided on the left side and right side. The back wall 33 and the electric wire drawing portion 34 serve to guide the electric wires 100 from the electric wire drawing surface 18 in the rightward direction as illustrated. The electric wire cover 21 is mounted to the outer housing 19 when the cover lock portions 35 lock to the corresponding cover lock receiving portions 24 of the outer housing 19.

Although not illustrated, a lever lock receiving portion is provided at a rear end portion of the back wall 33. When a later-described lever lock portion of the lever 14 locks in the lever lock receiving portion, rotation of the lever 14 is suppressed at a mating completion position to be described later.

The lever 14 includes a pair of cam plates 36 having a flat plate shape and a coupling portion 37 that couples the cam plates 36. The cam plates 36 are disposed with their plate surfaces oriented in the left–right direction. The cam plates 36 respectively have shaft holes 38 extending therethrough in the plate thickness direction and cam grooves 39 recessed in the inner surfaces of the cam plates 36. The shaft holes 38 are circular through holes. In a state where the lever 14 is mounted to the outer housing 19, the shaft holes 38 respectively receive the support shaft 25. A lower end of the coupling portion 37 in FIG. 2 is configured as the lever lock portion that is locked to the lever lock receiving portion, which is not illustrated in detail.

As shown in FIG. 7, the cam grooves 39 receive the cam pins 46 of the second connector 12. Each cam groove 39 has a cam entry port 40 that allows entry of the cam pin 46. The cam groove 39 extends from the cam entry port 40 to a cam rear end 41, which is a distal end of the cam groove. The cam groove 39 is curved from the cam entry port 40 to the cam rear end 41.

### Second Connector 12

The second connector 12 is mated with the first connector 11 from below the first connector 11. As described above, the second connector 12 includes the second housing 16, and the plurality of second terminal fittings 17 that are accommodated in the second housing 16. The second terminal fittings 17 are made of conductive metal. The second terminal fittings 17 have a pin shape that extends in the up-down direction. The second terminal fittings 17 are mounted to a later-described lower wall 45 of the second housing 16. Lower portions of the second terminal fittings 17 protrude downward from the second housing 16, and are connected to a circuit board (not illustrated).

The second housing 16 includes the second housing body 42 having a rectangular tubular shape, and a case mating portion 43 extending outward from a lower end of the second housing body 42. The case mating portion 43 has an oblong shape longer in the front-rear direction than in the left-right direction as viewed from above. As shown in FIG. 3, a seal mount portion 44 is provided in an outer peripheral surface of the case mating portion 43. The seal mount portion 44 is recessed over the entire periphery of the outer peripheral surface of the case mating portion 43. A seal member 31C made of rubber is mounted to the seal mount portion 44. In a state where the second connector 12 is fixed to the case 90, the seal member 31C is in intimate contact with an inner peripheral surface of the tubular portion 92 and the outer peripheral surface of the case mating portion 43 in a liquid-tight manner.

The second housing body 42 is formed in a rectangular tubular shape that is open upward. The lower wall 45 of the second housing body 42 is a portion that forms a bottom wall of the second housing body 42. Upper ends of the second terminal fittings 17 extend through the lower wall 45 and protrude inward from the second housing body 42. In the mated state between the first connector 11 and the second connector 12, the second housing body 42 is mated between the mating tubular portion 22 and the inner housing 20.

The cam pins 46 are provided to protrude outward from upper end portions of both the left and right walls of the second housing body 42, respectively. The cam pins 46 have a cylindrical shape. During the mating process between the first connector 11 and the second connector 12, the cam pins 46 are fitted into the through grooves 23 through the through holes 27.

Blocking portions 47 are respectively provided to protrude outward from lower end portions of both the left and right walls of the second housing body 42. In the mating state between the first connector 11 and the second connector 12, the blocking portions 47 are disposed to block the lower end portions of the through grooves 23 and the through holes 27. The blocking portions 47 are disposed coaxially with the cam pins 46 in the up-down direction, respectively. In other words, the center of each blocking portion 47 in the front–rear direction and the center of the corresponding cam pin 46 in the front–rear direction are positioned to coincide with each other in the front–rear direction. The blocking portions 47 and the cam pins 46 all protrude from the outer surfaces of the left and right walls of the second housing body 42 that extend along the up-down direction and the front-rear direction. In the first embodiment, as shown in FIG. 3, the protruding lengths of the blocking portions 47 from the outer surfaces and the protruding lengths of the cam pins 46 from the outer surfaces are the same. In other words, in the direction in which each blocking portion protrudes outward from the second housing body 42, a leading end of the blocking portion 47 is disposed at the same position as a leading end of the corresponding cam pin 46.

The blocking portion 47 has a block shape. The blocking portion 47 is integrally connected to an area extending from the outer surface to an upper surface of the case mating portion 43. The leading end surface (outer end surface) in the protruding direction of the blocking portion 47 protruding from the outer surface is continuous with and flush with the leading end surface (outer end surface) in the extending direction of the case mating portion 43. Both front and rear end surfaces of the blocking portion 47 are disposed perpendicular along the up-down direction. The vertical lengths of the front and rear end surfaces of the blocking portion 47 are greater than the largest thickness of the inclined portions 28 of the extended portion 26. Thus, as shown in FIG. 7, in the mated state between the first connector 11 and the second connector 12, an upper end portion of the blocking portion 47 protrudes upward to be higher than the extended portion 26.

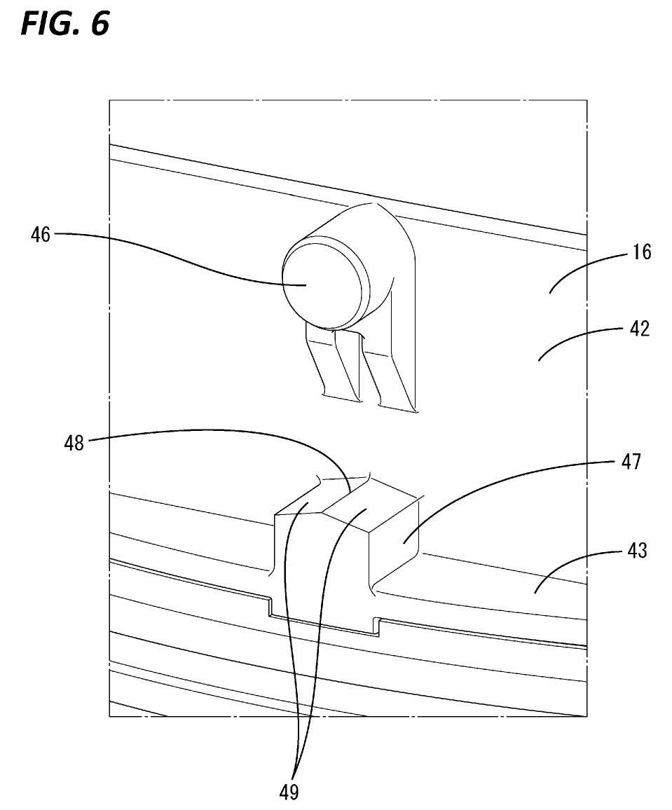

As shown in FIG. 6, the upper end of the blocking portion 47 has a ridge portion 48 extending in the left-right direction at an intermediate portion in the front-rear direction, and a pair of front and rear inclined surfaces 49 inclined downward from the ridge portion 48 toward front and rear sides. As shown in FIG. 7, in the mated state between the first connector 11 and the second connector 12, the inclined surfaces 49 are inclined downward toward the extended portion 26. In addition, lower end portions of the cam plates 36 of the lever 14 closely face the blocking portions 47 in the up-down direction, respectively.

### Operation of Mating First Connector 11 and Second Connector 12

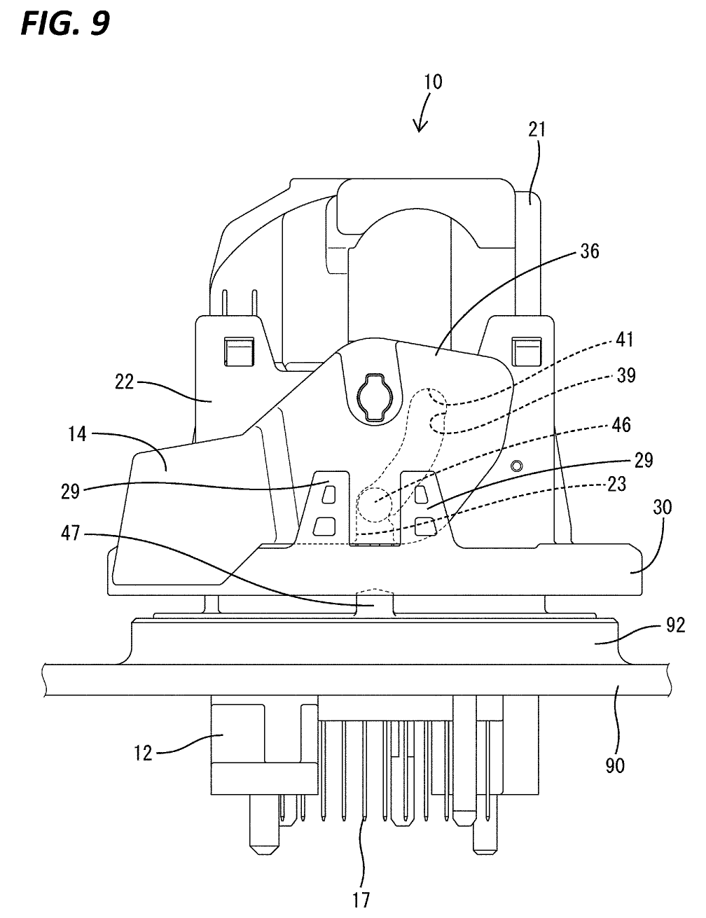

Next, an operation of mating the first connector 11 and the second connector 12 with each other will be described. At the start of mating between the first connector 11 and the second connector 12, the cam entry ports 40 are disposed to come into communication with the lower end portions of the through grooves 23, and come into communication with the through holes 27 in the up-down direction, while facing downward. In this state, the first connector 11 and the second connector 12 are shallowly mated with each other (see FIG. 9). As a result, leading ends of the cam pins 46 enter the cam entry ports 40 through the through holes 27, respectively. Base ends of the cam pins 46 enter the lower end portions of the through grooves 23, respectively. The coupling portion 37 is positioned rearward of the mating tubular portion 22.

Next, while the coupling portion 37 is griped, the lever 14 is rotated about the support shafts 25 toward a mating completion position. During the rotation process of the lever 14, the cam pins 46 slide along the surfaces of the cam grooves 39 toward cam rear ends 41. The first connector 11 and the second connector 12 are drawn toward each other by the cam action between the lever 14 and the second connector 12. In the process of moving the lever 14 from the mating start position to the mating completion position, outer peripheral edges of the cam plates 36 (lower end edges of the cam plates 36 in FIG. 2) are positioned apart from the blocking portions 47.

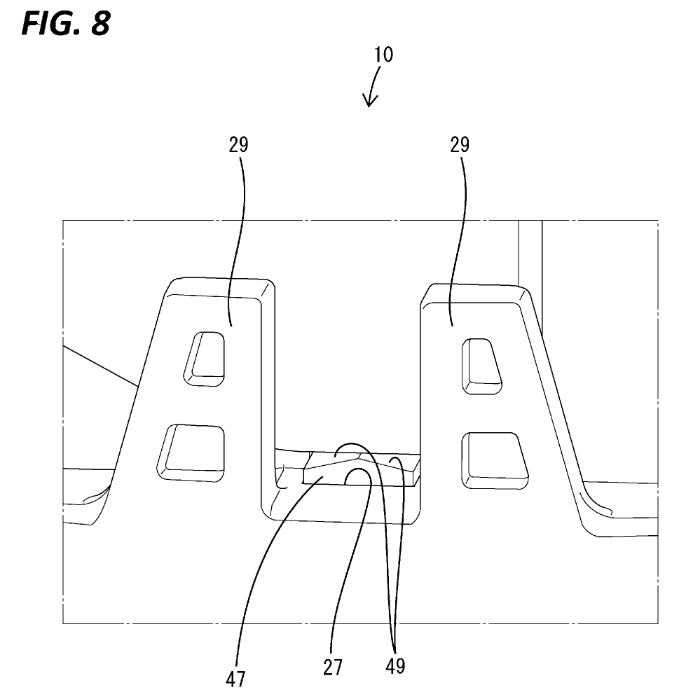

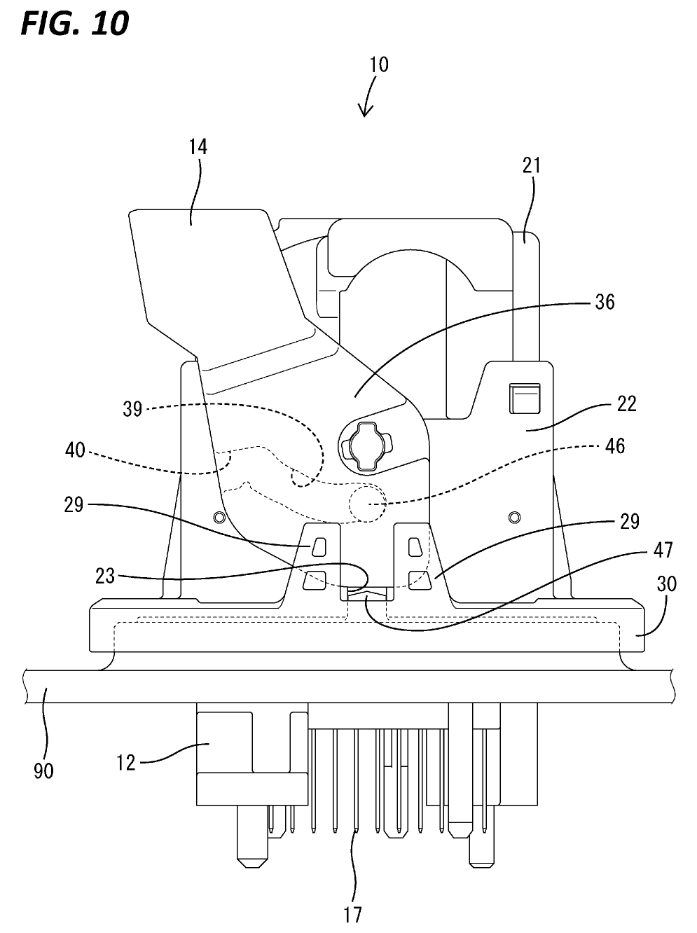

When the lever 14 is at a position where the cam pins 46 reach the cam rear ends 41, that is, the mating completion position, the lever lock portion of the lever 14 locks to the lever lock receiving portion of the electric wire cover 21. Accordingly, rotation of the lever 14 to the mating start position is limited, and, at the same time, the first connector 11 and the second connector 12 are held in the mated state. As shown in FIG. 10, when the lever 14 is at the mating completion position, the outer peripheral edges of the cam plates 36 are respectively disposed closely to the blocking portions 47. In addition, when the lever 14 is at the mating completion position, higher portions of the through grooves 23 than the lower end portions are respectively covered with the cam plates 36 of the lever 14 (see FIG. 7). Furthermore, the blocking portions 47 are disposed in regions extending from the lower end portions of the through grooves 23 to the through holes 27, respectively. In other words, the blocking portions 47 are mated with portions extending from the lower end portions of the through grooves 23 to the through holes 27. Specifically, the end surfaces in the front-rear direction of the blocking portions 47 and left and right outer end surfaces of the blocking portions 47 face end edges of the respective through holes 27 in a contactable manner (see FIG. 8).

### Operations of Connector 10

Next, operations of the connector 10 configured as described above will be described.

When the first connector 11 is exposed to water in the mated state between the first connector 11 and the second connector 12, the facing walls 29 can initially keep water from entering the through grooves 23 and the through holes 27. In addition, even when water flows to a region between a pair of front and rear facing walls 29, the cam plate 36 covers a higher portion of the through groove 23 than the lower end portion and the blocking portion 47 blocks the lower end portion of the through groove 23 and the through hole 27, making it possible to subsequently keep water from entering the through groove 23 and the through hole 27. Furthermore, even when the blocking portion 47 is exposed to water, the water can be guided to the extended portion 26 by the inclined surfaces 49 of the upper end of the blocking portion 47. The water guided from the inclined surfaces 49 can be drained to the outside of the connector 10 using the inclined portions 28 of the extended portion 26.

The connector 10 according to the present disclosure includes the first connector 11, and the second connector 12 that is mated with the first connector 11 from below. The first connector 11 includes the first housing 13 including the mating tubular portion 22, and the lever 14 rotatably supported by the first housing 13. The second connector 12 includes the second housing body 42 that is disposed inside the mating tubular portion 22 in the mated state between the first connector 11 and the second connector 12, and the cam pins 46 protruding outward from the second housing body 42. The lever 14 includes the cam plates 36 that are disposed outside the mating tubular portion 22, and the cam plates 36 have cam grooves 39 that engage with the respective cam pins 46. The mating tubular portion 22 has the through grooves 23 that extend in the up-down direction and through which the cam pins 46 are respectively inserted. The first housing 13 has the extended portion 26 extending outward from the lower end portion of the mating tubular portion 22. The extended portion 26 is provided with the through holes 27 that are in communication with the lower end portions of the respective through grooves 23. The second housing body 42 has the blocking portions 47 that extend from the lower end portions of through grooves 23 to the through holes 27, in the mated state between the first connector 11 and the second connector 12.

Since the connector 10 is a lever-type connector provided with the lever 14, the through holes 27 and the through grooves 23 need to be formed in the extended portion 26 in order to insert the cam pins 46 into the first housing 13. In view of such circumstances, in the connector 10 according to the present disclosure, the second housing body 42 has the blocking portions 47. The blocking portion 47 can block the end portions of the through grooves 23 and the through holes 27 in the mated state between the first connector 11 and the second connector 12. Accordingly, for example, even when the first connector 11 is exposed to water, water or the like can be prevented from entering the second connector 12 side from the first connector 11 side due to the blocking portions 47. Thus, under the circumstances that providing the lever 14 results in formation of the through grooves 23 and the through holes 27, the connector 10 can improve water resistance.

The blocking portions 47 are disposed to protrude outward from the second housing body 42, below the cam pins 46. In the direction in which each blocking portion 47 protrudes outward from the second housing body 42, the leading end surface of the blocking portion 47 is positioned at the same position as the leading end surface of the corresponding cam pin 46 or outward of the leading end surface of the cam pin 46 (see FIG. 2). Accordingly, a protruding length of the blocking portion 47 can be set so as to block the through hole 27, and thus water resistance can be secured.

Each cam plate 36 covers a higher portion of the through groove 23 than the lower end portion in the mated state between the first connector 11 and the second connector 12. Accordingly, due to both the cam plates 36 and the blocking portions 47, water or the like can be prevented from entering the through grooves 23.

The first housing 13 has the facing walls 29 that face the outer surfaces of the cam plates 36. In the mated state between the first connector 11 and the second connector 12, a pair of facing walls 29 are disposed on opposite sides of each blocking portion 47 as viewed from outside. Accordingly, also due to the facing walls 29, water can be prevented from entering the through grooves 23 and the through holes 27. In addition, as shown in FIG. 8, by visually recognizing the blocking portion 47 from between the pair of facing walls 29 disposed in the front-rear direction, it is possible to detect that the first connector 11 and the second connector 12 are in the mated state.

As shown in FIG. 7, the upper end of the blocking portion 47 has the inclined surfaces 49 that are positioned above the extended portion 26 in the mated state between the first connector 11 and the second connector 12, and are inclined downward toward the extended portion 26. Accordingly, the inclined surfaces 49 can function as drainage surfaces for directing water to the extended portion 26 side. For example, even when a blocking portion 47 is exposed to water, water flows to the extended portion 26 in accordance with the inclination of the inclined surfaces 49, and thus water or the like can be more reliably kept from entering the through groove 23 and the through hole 27.

Furthermore, in the first embodiment, as shown in FIG. 7, on the upper surface of the extended portion 26, the inclined portions 28 are provided on opposite sides of the through hole 27 as viewed from outside. The inclined portions 28 are inclined downward toward the front and rear sides from front and rear opening ends of the through hole 27. Accordingly, even when the blocking portion 47 is exposed to water, water guided from the inclined surfaces 49 can be efficiently drained using the inclined portions 28.

### Other Embodiments of the Present Disclosure

The embodiment disclosed herein is an example in all respects and should not be interpreted as limiting in any manner.

In the first embodiment, the case 90 is made by aluminium die casting. In contrast, in another embodiment, the case may be formed from a metal plate or the like instead of aluminium die casting.

In the first embodiment, the inclined surfaces 49 are inclined downward to the front and rear sides from the ridge portion 48 of the upper end of the blocking portion 47. In contrast, in another embodiment, the upper end of a blocking portion may be inclined only in one direction. Specifically, the upper end of the blocking portion may be inclined downward to the front, or upward to the front.

In the first embodiment, the lever 14 is held on the mating tubular portion 22. In contrast, in another embodiment, the electric wire cover 21 may hold the lever 14.

In the first embodiment, the first connector 11 is a female connector that accommodates the first terminal fittings 15 that are female terminals, and the second connector 12 is a male connector that accommodates the second terminal fittings 17 that are male terminals. In contrast, in another embodiment, the male-female relationship between the first connector and first terminal fittings and the second connector and second terminal fittings may be reversed. Specifically, the first connector may be a male connector that accommodates first terminal fittings that are male terminals, and the second connector may be a female connector that accommodates second terminal fittings that are female terminals.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a first connector; and
a second connector that is mated with the first connector from below,
wherein the first connector includes a first housing including a mating tubular portion, and a lever rotatably supported by the first housing,
the second connector includes a second housing body that is disposed inside the mating tubular portion in a mated state between the first connector and the second connector, and a cam pin protruding outward from the second housing body,
the lever includes a cam plate that is disposed outside the mating tubular portion, the cam plate including a cam groove that engages with the cam pin,
the mating tubular portion includes a through groove that extends in an up-down direction and through which the cam pin is inserted,
the first housing includes an extended portion extending outward from a lower end portion of the mating tubular portion,
the extended portion is provided with a through hole that is in communication with a lower end portion of the through groove, and
the second housing body includes a blocking portion that is disposed to extend from the lower end portion of the through groove to the through hole in the mated state.

2. The connector according to claim 1,
wherein the blocking portion is disposed to protrude outward from the second housing body, below the cam pin, and
in a direction in which the blocking portion protrudes outward from the second housing body, a leading end surface of the blocking portion is positioned at the same position as a leading end surface of the cam pin or outward of the leading end surface of the cam pin.

3. The connector according to claim 2,
wherein in the mated state, the cam plate covers a higher portion of the through groove than the lower end portion.

4. The connector according to claim 3,
wherein the first housing includes facing walls that face an outer surface of the cam plate, and
in the mated state, a pair of facing walls are disposed on opposite sides of the blocking portion as viewed from outside.

5. The connector according to claim 1,
wherein an upper end of the blocking portion has an inclined surface that is positioned above the extended portion in the mated state, and is inclined downward toward the extended portion.
